(19) United States
(12) Patent Application Publication
(10) Pub. No.: US 2009/0229526 A1
(43) Pub. Date: Sep. 17, 2009

(54) Fluid treatment system

(76) Inventor: Rex Allan Mason, Auckland (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/575,960

(22) PCT Filed: Oct. 12, 2004
(86) PCT No.: PCT/NZ04/00249

§ 371 Date: Feb. 22, 2008

(30) Foreign Application Priority Data
Oct. 13, 2003 (NZ) 528893

(51) Int. Cl. A01J 5/00; A01J 11/04; A01J 11/00

(52) U.S. Cl. 119/14.02; 119/14.01

(57) ABSTRACT

According to one aspect of the present invention there is provided an improved fluid treatment system, including a low-pressure source, where the low-pressure source imparts a low pressure to at least part of the internal volume of the improved fluid treatment system, and at least one fluid inlet (5), and a primary chamber (2), wherein the primary chamber (2) contains at least one baffle (7) adapted to control the flowrate of fluid out of the primary chamber (2), and, a secondary chamber (3), wherein the secondary chamber (3) defines at least one inclined surface (4), and at least one fluid outlet (10), characterised in that, fluid entering from the fluid inlet (5) is pooled between the primary chamber (2) wall and the baffle (7) before flowing out of the primary chamber (2) past the baffle (7) to form a thin film laminar flow on at least part of the surface of the secondary chamber (3) to remove at least part of the gas entrained within the fluid.

### TECHNICAL FIELD

This invention relates to an improved fluid treatment system.

In particular, this invention relates to an improved fluid treatment system for use in animal husbandry where the milking of an animal is required.

Reference throughout the specification shall now be made to use of the present invention in relation to the milking of animals, and in particular cows, within a milking shed.

However, this should not necessarily be seen to be a limitation on the present invention in any way as it may be used with other fluids than milk, or with other animals than cows, as well as in any other location where it is deemed to be suitable.

### BACKGROUND ART

The use of fluid treatment systems within the dairy industry is well known, particularly for the collection and storing of milk from a herd of animals.

Historically milk was manually extracted from animals. Milk was generally collected into a pail before being transferred to some form of holding tank prior to its disposal.

The advent of electromechanical milking equipment not only greatly improved the sanitation of the old system, it also improved the yield considerably.

Another improvement with the electromechanical system is that the operator could milk more than one animal at a time.

The milk extracted from the animals was done so under a “system vacuum” (this reduced the air pressure within the milkline connected to the teat in order to extract the milk from the teat).

Due to the nature of both manual and electromechanical extraction of milk from an animal a volume of air becomes entrained within the milk prior to the milk entering a bulk storage tank.

Although the electromechanical milking systems overcome most of the problems associated with the previous manual milking method they do not overcome the problems associated with the introduction of entrained air into the product.

One of the main drawbacks of the presence of entrained air is that a greater volume is needed to store the product as the air increases the overall volume of the product.

This also introduces a further drawback for the farmer in that when tested the milk indicates that it has a lower milk solids content per litre due to the presence of the entrained air.

A further drawback with the introduction of air into the product is that it can encourage the proliferation of aerobic bacteria developing within the milk.

Yet another problem caused by the introduction of air is that under certain temperature conditions foaming of the milk will be more prevalent.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an improved fluid treatment system, including

a low-pressure source, wherein the low-pressure source imparts a low pressure to at least part of the internal volume of the improved fluid treatment system, and
at least one fluid inlet, and
a primary chamber, wherein the primary chamber contains at least one baffle adapted to control the flowrate of fluid out of the primary chamber, and,
a secondary chamber, wherein the secondary chamber defines at least one inclined surface, and
at least one fluid outlet,
characterised in that,
fluid entering from the fluid inlet is pooled between the primary chamber wall and the baffle before flowing out of the primary chamber past the baffle to form a thin film laminar flow on at least part of the surface of the secondary chamber to remove at least part of the gas entrained within the fluid.

According to another aspect of the present invention there is provided a method of treating fluid characterised by the steps of
a) introducing the fluid to a fluid treatment system which includes a low-pressure source, which imparts a low pressure to at least part of the internal volume of the improved fluid treatment system, at least one fluid inlet, a primary chamber, which contains at least one baffle adapted to control the flowrate of fluid out of the primary chamber, a secondary chamber, which defines at least one inclined surface, at least one fluid outlet,
   wherein fluid entering from the fluid inlet is pooled between the primary chamber wall and the baffle before flowing out of the primary chamber past the baffle to form a thin film laminar flow on at least part of the surface of the secondary chamber to remove at least part of the gas entrained within the fluid, and
b) removing fluid from the treatment system.

It should be appreciated that in many embodiments of the present invention some of the gas and vapour entrained within the fluid will also be released in the primary chamber.

It should be appreciated that the thin film of fluid present in the secondary chamber creates a large meniscus to the low-pressure source and hence a large area for gas/vapour exchange.

Throughout the present specification the secondary chamber will now be referred to as having a single inclined surface.

However this should not be taken to be a limitation on the present invention in any way as it is equally feasible that the secondary chamber may have a number of inclined surfaces.

It should be understood that the angle of inclination of the secondary chamber surface will control the rate of flow of a fluid on said surface.

It should also be appreciated that texturing of the secondary chamber surface may also be utilised to decrease the velocity of a fluid flowing over the surface.

The shallower the angle of inclination of the surface of the secondary chamber, or the greater the level of texturing on the surface of the secondary chamber, will slow the flowrate of a fluid over the surface of the secondary chamber and hence will expose the thin film of fluid to the low-pressure source (system vacuum) for a greater period of time to increase the amount of entrained gas and vapour that is removed.

In some embodiments of the present invention the secondary chamber entry has a radius rather than a sharp profile. This ensures that no additional air is introduced through any turbulence which would occur from passing over a sharper profile. This will also control the flow pattern into the secondary chamber.

It should be appreciated that if required these parameters can be defined for each installation of the present invention to achieve the optimum performance for that particular installation.

It should be appreciated that a crude version of the present invention can be formed by using part of the fluid inlet to form the primary chamber with its end face in close proximity to an inclined surface.

In this configuration the gap between the end face and the inclined surface will act as the baffle with the inclined surface being the secondary chamber.

This configuration (or variations of it) should be understood to be far from ideal as the removal of moisture and entrained gas from within the primary chamber will be greatly reduced as well as the fact that the fluid flow over the secondary chamber surface will be limited to an area in proximity to the fluid inlet and the area beneath it.

There may also be the problem of splashing and/or inconsistent flowrate of the fluid. These problems also occur if there is no gap at the base of the baffle and the fluid is allowed to flow over the top of the baffle in a similar manner to a weir.

This configuration could also pose significant hygiene problems due to the difficulty of achieving an adequate level of cleanliness in the area where the fluid pools behind the baffle.

In this configuration the thickness of the laminar film on the surface of the secondary chamber will be determined by the instantaneous flowrate of the fluid exiting the inlet and would therefore be inconsistent and impossible to control or predict.

Therefore in some embodiments of the present invention the primary chamber may be taken as being part of the fluid inlet and the baffle as the space in between the exit of the fluid inlet and the secondary chamber.

In this configuration some pooling of the fluid in the primary chamber can still occur as there is generally a void above the fluid in the fluid inlet under normal operating conditions—this void can be as large as 50% or more.

However it can be readily seen that these crude embodiments are far from ideal and it is not envisaged that they will be seriously considered for manufacture. However they are mentioned as falling within the general scope of the present invention.

Throughout the present specification the term “fluid inlet” should be understood to mean a point or aperture through which the collected fluid is introduced to the present invention.

In preferred embodiments of the present invention a plurality of fluid inlets are utilised, each introducing the milk substantially tangentially to the circumference of the primary chamber in order to impart a “swirling action” to the fluid.

This provides a relatively free flow of fluid into the primary chamber, which will allow the fluid to pool in the primary chamber and not in the inlet pipe.

This swirling action combined with the exposure of the fluid to the low-pressure source will lower the temperature of the fluid with the result that moisture will be released from the fluid and as well as any moisture exiting a fluid inlet will be removed from the present invention by the low-pressure source.

This lowering of temperature is also very useful in the dairy industry where milk is required to be cooled as part of its usual treatment.

Throughout the present specification the term “low-pressure source” should be understood to mean the system vacuum of the milking equipment that is used with the present invention and to extract milk from the animal.

However, this should not be seen to be a limitation on the present invention in any way as in other embodiments a separate low-pressure source can be connected to the preset invention in order to assist in its correct operation.

The term “baffle” used throughout the present specification should be understood to mean a plate or other obstruction that affects the flow of the fluid from the fluid inlet into the primary chamber and controls the fluid flow from the primary chamber into the secondary chamber.

In preferred embodiments of the present invention the baffle is substantially vertical and has a gap along at least part of its base to control the flow of the fluid from the primary chamber into the secondary chamber.

In other embodiments the baffle can be canted towards the horizontal to assist in the flow of any removed vapours from the primary chamber.

It should also be understood that the preset invention will have a fluid outlet positioned substantially towards the base of the present invention, through which the fluid will be removed and passed to a storage tank or to other equipment used within the treatment of the fluid.

It should be understood that the gap at the base of the baffle is used to determine the amount of fluid exiting the primary chamber at any given time and hence will also control the thickness of the laminar film of fluid that passes over the surface of the secondary chamber.

In preferred embodiments of the present invention this gap will be less than 5 millimetres.

However, in some other embodiments (particularly where quite viscous fluids are present) the gap may be larger than this in order to ensure an adequate fluid flow is formed across the secondary chamber surface.

It is envisaged that within most embodiments of the present invention the gap between the surface of the baffle and the primary or secondary chamber is fixed.

However this should not be seen to be a limitation on the present invention in anyway as in other embodiments it is equally feasible that the gap can be adjustable—particularly where the same piece of equipment may be used with fluids of different viscosities or with different sources of low pressure (in order to adequately control the flow of fluid through the present invention).

It can be seen from the foregoing that the present invention has many significant advantages over the milking systems currently in use.

One significant advantage is that due to the removal of most of the entrained gas and vapour the present invention will strip odours and “off” flavours from the milk, thereby improving the organoleptics.

By deodorising the milk the present invention will make the milk more appealing to a greater variety of people as currently a number of people and/or processes are intolerant to the odours and “off” flavours.

Another great advantage of the present invention is that due to the system vacuum producing a lower temperature within the milk several effects take place:
1. this assists in the thermal evaporation of gas and vapours from the milk,
2. the present invention captures any condensable vapours and separates them from the milk,
3. the milk exits the present invention at a lower temperature to that at which it enters and therefore less energy is needed to cool the milk in its' final storage tank.

Another advantage is that any aerobic bacterial development within the milk is reduced due to the removal/reduction of any entrained gas and vapour from within the milk.

Another significant advantage of the present invention is that by removing entrained gas and vapours the overall volume of the milk will be reduced which will therefore mean that the milk will take up a smaller storage space and when tested will register a higher milk solids percentage which will in turn provide a financial gain to the farmer.

It can therefore be seen that use of the present invention provides gains to both the farmer and the end-user as the product is cooled faster, is of lesser volume and will have had any unpleasant odours removed.

### BRIEF DESCRIPTION OF DRAWINGS

Further aspects of the present invention will become apparent from the following description which is given by way of example only and with reference to the accompanying drawings in which:

FIG. 1 is a diagrammatical representation of a section view of the present invention cut through its vertical mid-line,

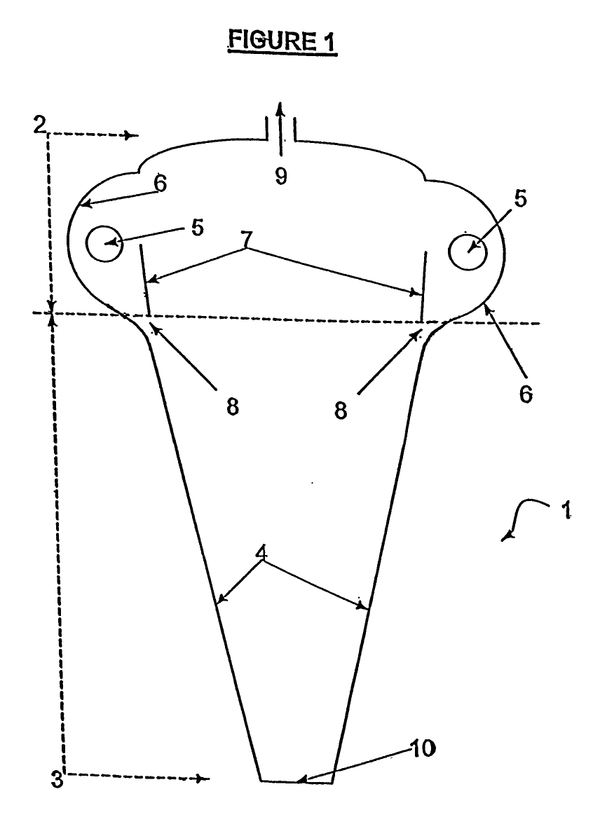

FIG. 2 is a diagrammatical representation of a plan view of the present invention.

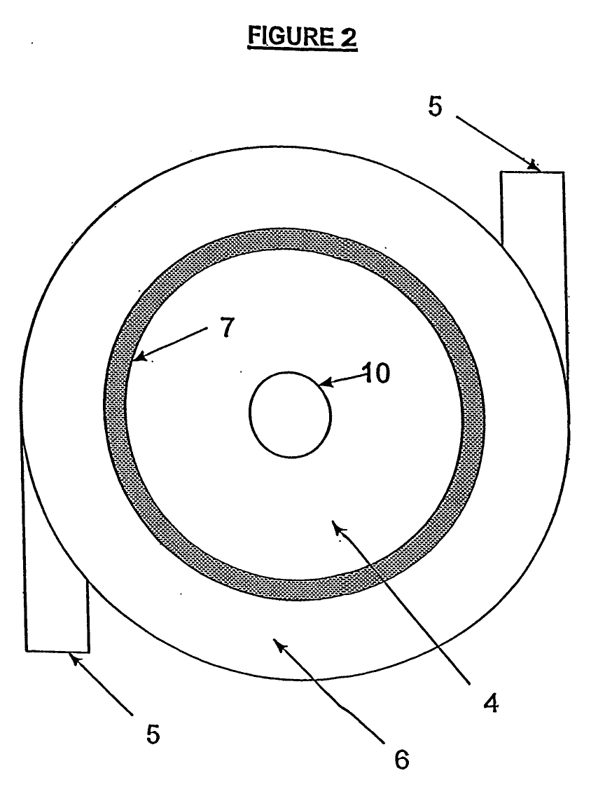

### BEST MODES FOR CARRYING OUT THE INVENTION

With reference to the figures there is illustrated an improved fluid treatment system generally indicated by arrow 1.

The improved fluid treatment system (1) is split into two chambers, the primary chamber (2) and the secondary chamber (3).

It should be appreciated that the most efficient shape for the present invention with respect to its footprint within the installed work place is to have a circular plan view, with the secondary chamber (3) having a vertically conical side wall (4).

It should be appreciated that any other shape that can form a thin film laminar flow on at least part of its surface can be used to replace the conical side walls (4).

The primary chamber (2) has a number of fluid inlets (5) which provide fluid to the present invention.

The fluid used with the present invention will now be referred to as milk from milking equipment installed within a milking parlour or shed.

The milk is introduced to the primary chamber (2) tangentially to the radius of the primary chamber (2) via fluid inlets (5) in order to impart a swirling action on the milk which is collected between the outer wall (6) of the primary chamber (2) and the baffle (7).

The baffle (7) is installed within the primary chamber (2) in such a fashion that there is a small gap (8) at, or towards, the base of the baffle (7) in order that the milk which is pulled within the primary chamber (2) between the outer wall (6) and the baffle (7) can exit the primary chamber (2) and flow down the inclined wall (4) of the secondary chamber (3).

The dimensions of the gap (8) will determine the thickness of the layer of milk which exits the primary chamber (2) via the gap (8).

It is envisaged that this gap (8) will be set at a few millimetres in order to ensure that the milk passing through the gap (8) will form a thin film laminar flow onto the inclined surface for the secondary chamber (3) so as to provide a large surface area of milk that is exposed to the system vacuum (9) that is present throughout the internal volume of the present invention (1).

The angle of inclination of the sides (4), as well as the surface texture of the secondary chamber (3), will determine the flow rate of the milk along the surface (4) and this will ideally be set so that the milk will have sufficient time, for most, if not all, of the entrained gas and vapours within the milk, to be exposed to the system vacuum (9) and hence drawn off from the milk.

Once the milk has reached the base of the secondary chamber (3) it will exit the improved fluid treatment system (1) via the fluid outlet (10).

Aspects of the present invention have been described by way of example only and it should be appreciated that modifications and additions may be made thereto without departing from the scope of the appended claims.

1. An improved fluid treatment system, comprising:
a low-pressure source, wherein the low-pressure source imparts a low pressure to at lest part of the internal volume of the fluid treatment system,
at least one fluid inlet,
a primary chamber wherein the primary chamber contains at least one baffle adapted to control the flowrate of fluid out of the primary chamber, and
a secondary chamber, wherein the secondary chamber defines at least one inclined surface,
at least one fluid outlet,
wherein fluid entering from the fluid inlet is pooled between the primary chamber wall and the baffle before flowing out of the primary chamber past the baffle to form a thin film laminar flow on at least part of the surface of the secondary chamber to remove at least part of the gas entrained with the fluid.

2. A fluid treatment system as claimed in claim 1 configured such that the thin film of fluid present in the secondary chamber creates a large meniscus to the low pressure source.

3. A fluid treatment system as claimed in claim 1 wherein the secondary chamber has a single inclined surface.

4. A fluid treatment system as claimed in claim 1 where the inner surface of the secondary chamber is inclined to control the rate of fluid.

5. A fluid treatment system as claimed in claim 1 wherein the secondary chamber inner surface is textured to decrease-velocity of a fluid flowing over the surface.

6. A fluid treatment system as claimed in claim 1 configured to allow fluid to pool in the primary chamber.

7. A fluid treatment system as claimed in claim 1 wherein there is a gap along at least part of the base of the baffle to control the flow of fluid from the primary chamber into the secondary chamber.

8. A fluid treatment system as claimed in claim 1 which has a fluid outlet positioned substantially towards the base of the system.

9. A fluid treatment system as claimed in claim 7 wherein the gap is less than 5 mm wide.

10. A method of treating fluid comprising:
a) introducing the fluid to a fluid treatment system which includes a low pressure source, which imparts a low pressure to at least part of the internal volume of the improved fluid treatment system, at least one fluid inlet, a primary chamber, which contains at least one baffle adapted to control the flowrate of fluid out of the primary chamber, a secondary chamber, which defines at least one inclined surface, at least one fluid outlet,
wherein fluid entering from the fluid inlet is pooled between the primary chamber wall and the baffle before flowing out of the primary chamber past the baffle to form a thin film laminary flow on at least part of the surface of the secondary chamber to remove at least part of the gas entrained with the fluid, and
b) removing fluid from the treatment system.

11-12. (canceled)
